(19) United States
(12) Patent Application Publication
(10) Pub. No.: US 2004/0122628 A1
(43) Pub. Date: Jun. 24, 2004

(54) Method and device for generating two-dimensional floor plans

(76) Inventor: Michael Stuart Laurie, Mississauga (CA)

Correspondence Address: Michael S. Laurie, 1059 Mesa Crescent, Mississauga, ON, L5H 4B5, CA

(21) Appl. No.: 10/724,259

(22) Filed: Dec. 1, 2003

Related U.S. Application Data
(60) Provisional application No. 60/430,584, filed on Dec. 3, 2002.

(51) Int. Cl. G06F 17/50

(52) U.S. Cl. 703/1

(57) ABSTRACT

A computer integrated floor plan system uses a distance measurement device, preferably laser-based, and an angle measurement device, such as a gyroscope, to measure the relative angles between objects. The absolute polar or Cartesian coordinates of each target are not measured in this system. Instead, wall lengths, distances and angles between wall and other building features are measured relative to each other, transmitted to an integrated CAD capable computer, and compared to manually generated walls, openings and other building features previously inputted into the computer by the operator. The use of a laser-based measuring system and error-checking functionality in its integrated CAD software ensures a high level of accuracy, without requiring extensive three-dimensional modeling, or the need for successive point to point measurements as in conventional surveying methods.

### RELATED U.S. APPLICATION DATA

This application claims the benefit of U.S. provisional application No. 60/430,584 filed on Dec. 3, 2002.

### TECHNICAL FIELD

The subject invention relates generally to the property management, building and construction industry, and more particularly to a novel method and device for mapping a building or other structure in two dimensions in order to generate digital floor plans.

### BACKGROUND OF THE INVENTION

The original floor plans and architectural blueprints for a structure are often lost or unavailable to a building's owners. Even if the original documents are available, these documents may also contain significant deviations from the building “as built”, due to renovations and other factors. Further, they may not be in a digital format, or are in a format no longer supported by existing software systems. In such cases, a labor and time intensive effort is needed to measure the data manually and generate new plans. The conventional method of using tape measurements is also inadequate because the level of accuracy is relatively poor.

An architect, renovator, property manager, appraiser or owner would prefer to avoid a costly and error-prone data entry process and generate, directly from the building, a two-dimensional floor plan of the structure as it currently exists.

To improve efficiency and accuracy, it is desirable to automatically record the measurements directly onto an electronic recording device and transfer the stored data to a computer for processing and generation of a finished plan in digital form. Several approaches have been proposed in the prior art, as described below.

U.S. Pat. No. 4,205,385, issued to Erickson et al., describes a surveying system that provides automatic calculation and direct readout of various parameters and vectors encountered during a survey. It comprises a theodolite, a level sensor, and an on board microcomputer that can be used in conjunction with an electronic distance measuring instrument. The device translates raw data, comprising horizontal angle, vertical angle, and slope range, into the more useful component vectors, horizontal distance, latitude, departure, and elevation. Measurements must be taken from a stationary traverse location that is fixed relative to the area or object being measured. The requirement of a stationary traverse location makes the measuring process tedious, time consuming, and expensive. Additionally, the user cannot view his work as it progresses for verification and correction, since this device does not operate as a real-time input device for a computer and associated applications software.

U.S. Pat. No. 5,091,869, issued to Ingram et al., proposes a complex method for devising a floor plan comprising the selection of traverse points, the setting up of a surveying instrument on the traverse point and measuring distances and angles to prominent points on the floor. A further traverse point is then selected and the process repeated until all the data are collected. The data is then transferred to a separate computer and converted into a floor plan. The gathering of the data, according to Ingram et al., is a demanding operation that requires at least two persons.

It would thus be advantageous to provide a method and device that overcomes the drawbacks of the prior art. For example, it would be beneficial to provide an integrated device that enables a single operator to devise digital floor plan in a relatively short time.

U.S. Pat. No. 5,675,514, issued to Lefebvre, describes a spatial data recorder that is easy to use and can be manipulated by a single operator. The recorder has a base module and a remote module, which are linked through an extendable cable. The length and the angular orientation of the extendable cable are measured to determine the relative spatial position of the remote module with respect to the base module. With this spatial data recorder, the base module must be repositioned relatively often, which increases the time required to devise the plan of a floor. Furthermore, the use of an extendable cable between the modules may, in some instances, hinder the use of the system.

While the prior art methods can be used to produce a floor plan of a building, they are all variations of traditional surveying methods that successively measure point to point, using multiple steps and triangulation to create needlessly complicated two and three dimensional models from which a two dimensional floor plan is produced.

### SUMMARY OF THE INVENTION

It is an object of the present invention to provide a novel device and method of creating two-dimensional floor plans which obviates or mitigates at least one disadvantage of the prior art.

According to a first aspect of the present invention, there is provided a method for generating a digital, two-dimensional floor plan for the exterior of an existing building. The method comprises drawing a first linear representation of a first object of a physical structure on the display screen of a portable computer using at least one input device, pointing at least one device that measures both distance and relative angles from the near corner position of said first object to the far corner position of said first object, transmitting said distance and angle to said portable computer, so that the length of the first linear representation can be adjusted to match an appropriate display scale, drawing a linear representation of a second object that is adjacent the first object, pointing said measuring device at the far corner position of said second adjacent object, to measure a new distance and angle, transmitting said second distance and angle to said portable computer so that the length of the second linear representation can be adjusted to match an appropriate display scale, and repeating the previous steps until the relative lengths and angles of every object of the structure is calculated and displayed onto a digital floor plan.

According to another aspect of the present invention, there is provided an apparatus for devising, on-site, a two dimensional floor plan from a physical structure, comprising a portable computer capable of running CAD software, at least one input device to manually sketch initial dimensions of objects within a physical structure onto a display screen of said computer, at least one portable device for measuring distances and angles between objects within a structure, means to transmit linear and angular measurements to said computer, and customized CAD software running on said computer that is configured to calculate an appropriate display scale to show on said screen, and to adjust the initial linear representations so that they conform to the calculated display scale, and to adjust the relative angles between objects based on the measurements received from said portable measuring device.

### BRIEF DESCRIPTION OF THE DRAWINGS

Embodiments of the present invention will now be described, by way of example only, with reference to the attached Figures, wherein:

FIG. 1 is a perspective view of an integrated instrument that both records and generates digital floor plans;

FIG. 2 is a schematic block diagram of the connections between the various components of the integrated instrument of FIG. 1;

FIG. 3 depicts the procedure for generating floor plans for exterior walls;

FIG. 4 depicts a schematic top plan view of a generic building, used in conjunction with the exterior floor plan procedure of FIG. 3; and

FIG. 5 through FIG. 8 depict schematic top plan views illustrating a simulation for generating floor plans for interior walls.

### DETAILED DESCRIPTION OF THE PREFERRED EMBODIMENTS

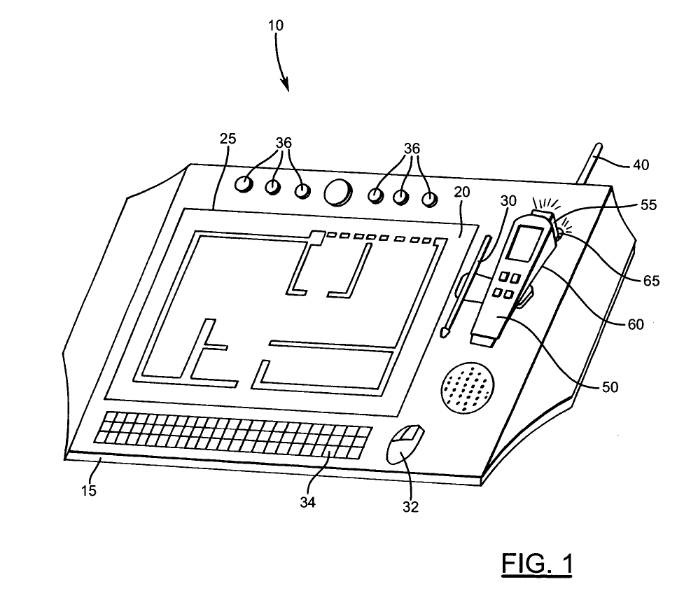

FIG. 1 illustrates an instrument, denoted generally at 10 and constructed according to the invention, used to measure wall lengths in a building or structure in the example under consideration. In the FIG. 1 embodiment, the instrument 10 is held without any form of mechanical support. In this embodiment, the instrument 10 is small and light enough to be held with one person's arm, and consists of a thin, rectangular housing 15 that encloses a computer 20 and related operating system required to run a customized computer aided drafting (CAD) program. The upper surface of instrument 10 is substantially composed of a touch sensitive screen or pen tablet 25. Adjacent to the screen is an input device, which may include, but not restricted to, a stylus 30, mouse 32, and keyboard 34. A series of pre-programmed buttons 36 may also be included next to the screen, whose purpose will be explained shortly.

Also included with the instrument is a detachable, distance-measuring unit 50. Laser-based measurement units are common in the field, and include, for example, a handheld Leica Disto™ class 2 laser with accuracy of ±3 mm or better. Since a laser beam consists of electromagnetic radiation traveling at the speed of light, very accurate measurements can be performed with this type of unit.

It is also pointed out that the distance-measuring device 50 of the instrument illustrated may also be designed in such a manner as to require the placement of reflectors on each measuring point. This embodiment would not be preferred because the measurement setup would be more complicated. Alternatively, mechanical or sonar type devices can also be used to measure distance.

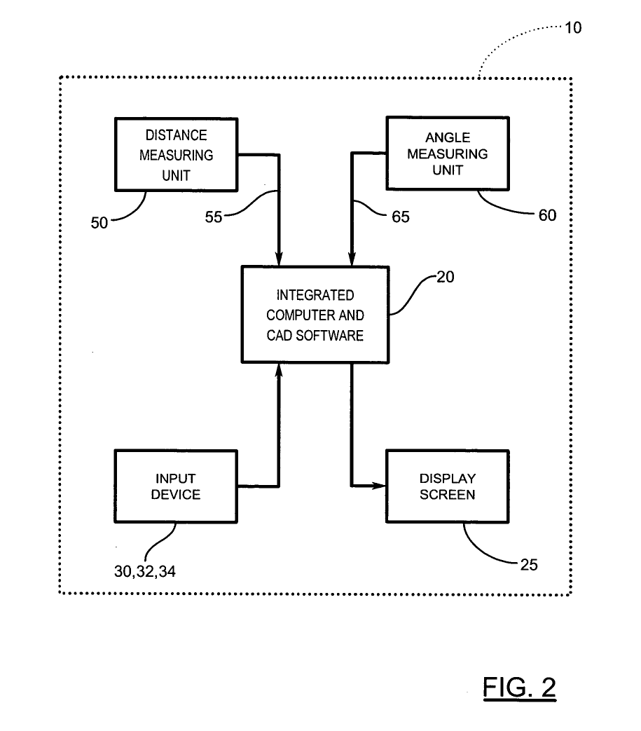

As more clearly seen in FIG. 2, the distance-measuring unit 50 is outfitted with a data transfer device 55, preferably wireless-based, that allows the transfer of recorded data into the integrated computer via a receiver 40. Also included with said distance-measuring unit 50 is a measuring unit 60 that measures the relative angle between two surfaces, or other building features, such as the angle between a wall and a column used in triangulation or an angle between a surface and a corner between another set of walls, again for triangulation purposes. The angle-measuring unit transmits said data via a data transfer device 65 to a receiver 40. Preferably, the angle-measuring unit is a gyroscope. Alternatively, a theodolite can be used.

The data transfer devices 55, 65 between the computer 30 (via receiver 40) and the distance and angle-measuring units, respectively, preferably operate in a wireless manner.

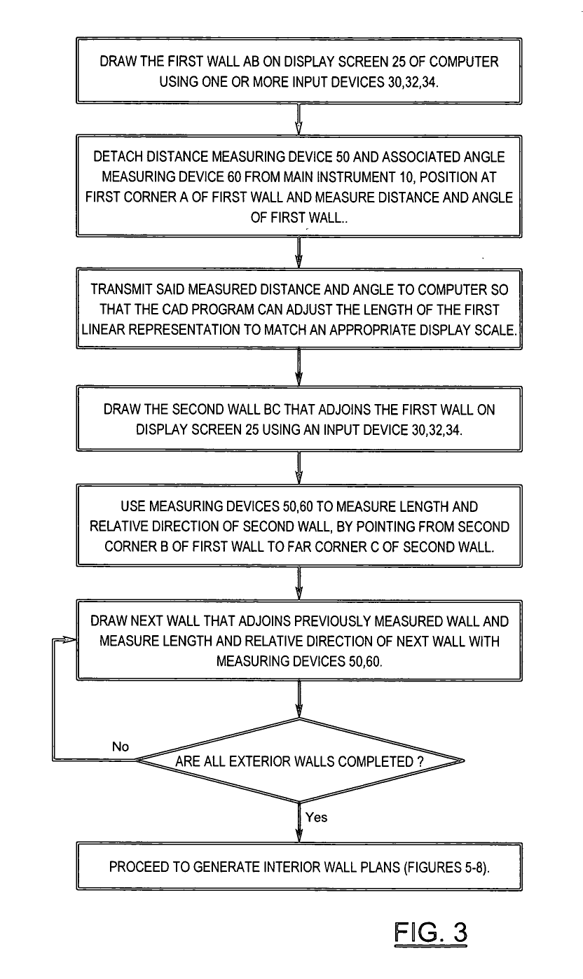

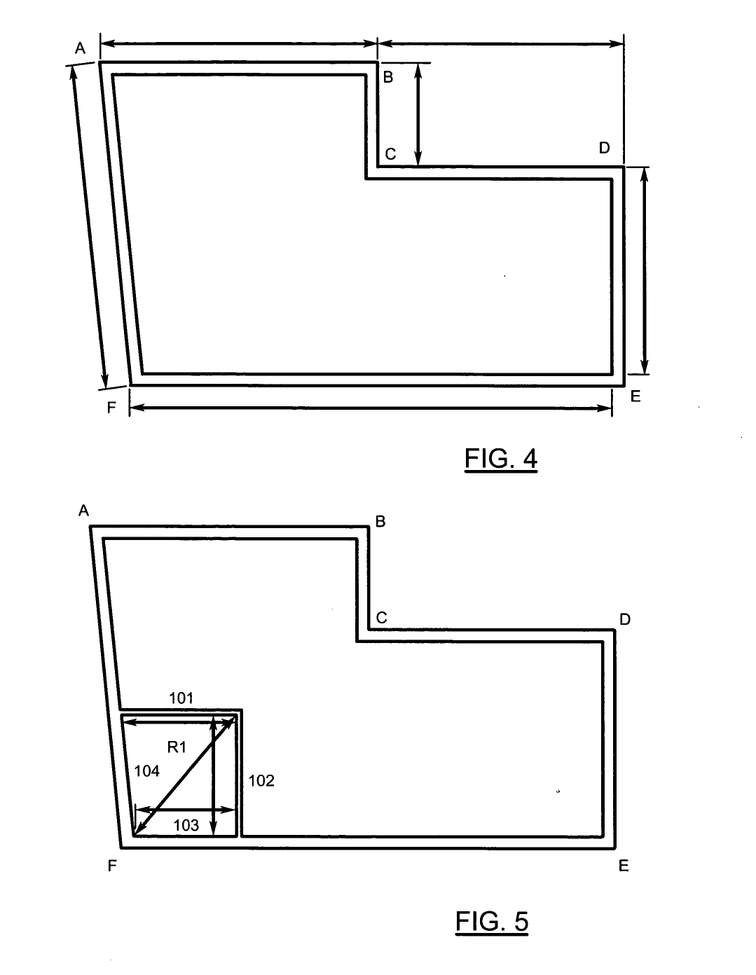

In a general mode of operation, the operator would first sketch out the floor plan of the structure of interest using one or more of the input devices 30, 32, and 34. Then, the distance-measuring unit and associated angle-measuring unit is removed and held by the operator in order to measure the dimensions of each room, as described below. The sequence of steps provided in the system and method of the invention are detailed in FIG. 3 and schematically illustrated in FIG. 4 through FIG. 8.

Ideally, the exterior floor plan is generated first. The instrument is set up outside the building to be measured, with small laser targets protruding slightly from each corner of the building. The targets do not need to be reflective in nature. Only one person is required to both measure dimensions and generate floor plans.

Alternatively, mechanical or sonar type devices can be used to measure distance in order to dispense with the need for reflectors or targets.

As a further alternative, if CAD drawings or other digital representations of the exterior top plan view exist, they can be imported into the customized CAD software and the separate procedure for generating the interior floor plan can be followed.

As illustrated in FIG. 3 and FIG. 4, the operator first draws one of the outside perimeter walls AB on the pen tablet screen 25 using at least one input device, such as a stylus 30. The wall type (e.g. straight, curved) is chosen from a choice of options in the associated computer software, accessible for example, by pressing one or more buttons 36, or from a selection of drop down menus incorporated in the CAD software. More simply, the wall type may be set to straight as the default by the CAD software. The operator then positions the detachable distance-measuring unit 50 at any first corner of the perimeter, shown as corner A in perimeter wall AB in FIG. 4. The laser beam is directed parallel to the wall AB and directly at the target protruding from corner B, so that the distance from corner A to corner B is measured. The associated angle-measuring unit 60 is set to a zero reference angle. The data is transmitted to the computer and the CAD program adjusts the scale of the drawing displayed on the screen 25.

One of the adjoining walls, BC in the example, is then drawn on the screen 25. The operator then positions the measuring units 50, 60 at the junction of the first and second walls, corner B, and directs the laser to a target adjacent corner C to obtain an accurate reading for the length of the second wall BC, and the direction of wall BC relative to the first reference wall AB. In practice, this direction is usually close to 90 degrees. The relative distance and angle are transmitted to the computer and adjustments made to the sketched wall in proportion to the display scale.

Next, a third wall CD, adjoining the second wall BC, is drawn and the operator then directs the measuring units 50, 60 from the corner C to the far corner D, to obtain an accurate reading for the relative length and direction of the wall CD. The process is repeated around the entire perimeter of the house, setting the length with the distance-measuring unit 50 and the direction with the angle-measuring unit 60.

Referring now to FIG. 5 through FIG. 8, the use of the instrument for interior dimensions is illustrated to devise an interior floor plan having a plurality of walls. For each Figure, the plan is illustrated on the display screen 25, first as a sketch, then as a finished dimension once the distance and angle-measuring units 50, 60 are used to set the actual distance and direction between walls.

The operator first chooses one of the interior rooms in the corner as a starting point, labeled R1 in FIG. 5, and manually draws the two inside walls 101, 102 on the display device 25 using an input device, for example, a stylus 30. The wall type, in this example straight, is chosen by one of the pre-programmed buttons 36, or from a selection of drop down menus incorporated in the CAD software. More simply, the wall type may be set to straight as the default by the CAD software.

The other two walls, 103 and 104, form part of the exterior walls EF and FA, respectively, and are already defined in the CAD system from the previously determined exterior floor plan.

The operator then directs the detachable measuring units 50, 60 toward the actual interior corners to measure the relative lengths and directions. Ideally, the operator can start at one of the corners, for instance at the junction of walls 101 and 102, to directly measure the lengths of walls 101, 102 and indirectly measuring the lengths of walls 103 and 104 by triangulation. The lengths of these walls can also be verified by direct measurement. The relative lengths and angles are transmitted to the computer and the CAD software adjusts the sketched lines accordingly.

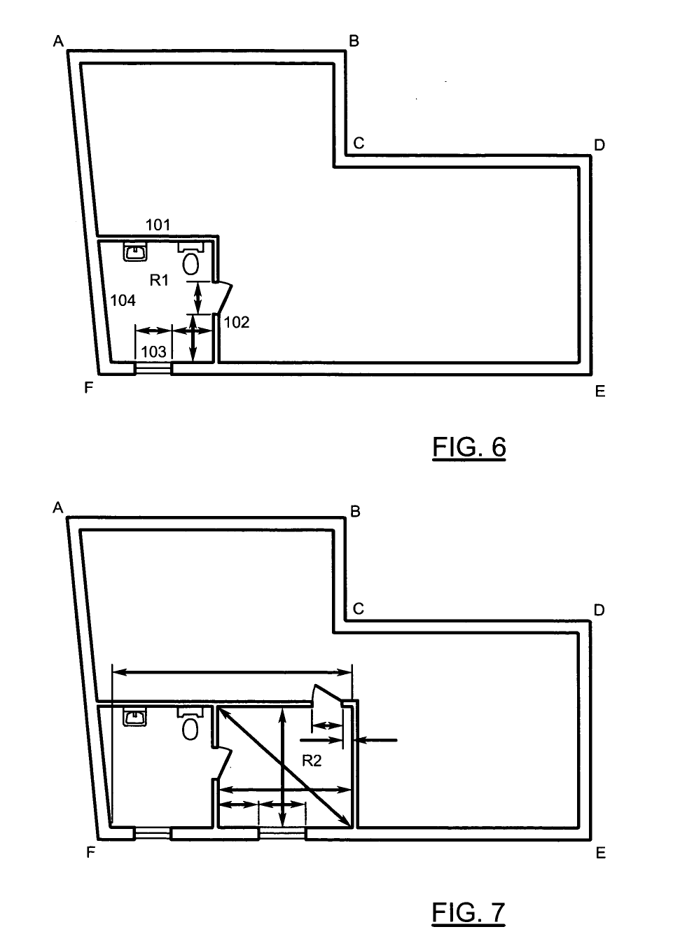

Next, in FIG. 6, the operator draws openings, fixtures, stairwells and other features by selecting from drop down menus incorporated in the CAD software, or by pressing one of the preprogrammed buttons 36. The distance-measuring tool 50 can correct the positioning directly on the CAD drawing.

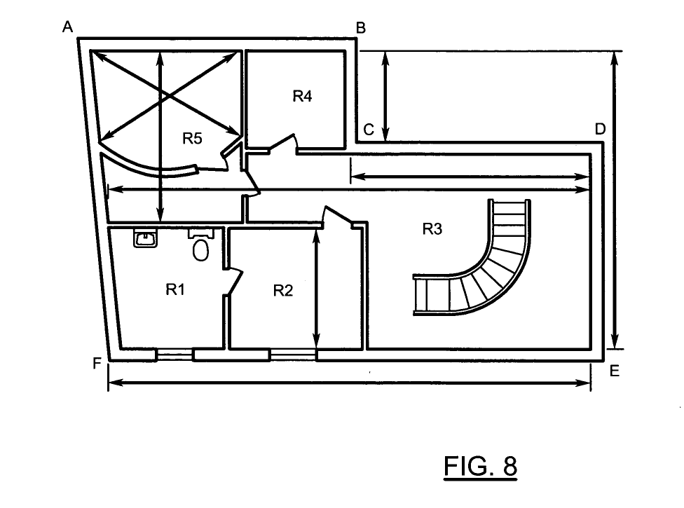

Next, in FIG. 7, the adjacent room R2 is sketched in by one or more input devices, including openings and other miscellaneous features. The measuring units 50, 60 are then used to correct for relative wall lengths and orientation, as in the same manner as previously described. The distances can be checked from the previous room, which eliminates the need to actually determine the wall thickness.

The previous step is repeated for each successive room, labeled as R3, R4, and R5 in FIG. 8. The distance-measuring unit can be used to measure overall dimensions as they become available, or to check against the anchor walls obtained from the exterior floor plan. When a particular room is finished, the CAD software prompts the operator to supply a name, and the room dimensions are then permanently stored onto the floor plan along with labels in digital format.

In all cases, the CAD system accepts relatively simple linear and angular input from the measuring units 50 and 60, respectively, and adjusts the distances and angles between linear representations displayed on a screen. Prior art systems measure absolute spatial data, usually in three dimensions, and transmit distances from the measuring unit to a base station. The applicant's disclosed system only transmits relative dimensions and angles and transforms initial linear representations into accurate scaled dimensions, never requiring a three-dimensional model. However additional “Z”-axis information such as ceiling heights, window heights, etc. are easily measured and recorded if the user so desires.

In a further embodiment, the instrument 10 also includes a GPS receiver, which allows the placement of a structure onto a street map, and a digital compass, which provides the orientation of a structure relative to magnetic north by placing and orienting a North Arrow on the plan relative to a predetermined direction such as the street-facing perimeter wall.

In another embodiment, a heads up screen and a virtual reality type control glove replaces the pen tablet 25 and input devices 30, 32, 34.

In yet another embodiment, measurement designation and other functions are controlled by voice recognition software.

In still another embodiment, the CAD program resides on a remote server, and the information is transmitted wirelessly to the central server and processed at the server in real time. This arrangement reduces the need for processing power on site and thus reduces the size and weight and the cost of the tablet computer, writing screen or heads up screen.

Although this invention has been described in conjunction with specific embodiments, many modifications and variations which do not depart from the scope of the invention, as defined by the attached claims, will be apparent to those skilled in the art.

What is claimed is:

1. An apparatus for establishing a two-dimensional layout of a physical structure, comprising:
a mechanism for forming a first linear representation of the layout of the exterior of the structure, the forming mechanism connected to an input device that generates the first representation;
a distance measuring device for scanning under the direction of an operator the exterior walls of the structure, starting at a first corner and scanning to a second distal corner, sequentially measuring the lengths of each exterior wall until all structure walls have been measured;
an angle measuring device for scanning under the direction of the operator the exterior walls of the structure, starting at the second corner and sequentially measuring the relative angles between adjacent walls until all relative angles between structure walls have been measured;
data transfer devices to transmit the distance and angle measurements; and
a memory which receives and stores the distance and angle data.

2. The apparatus as described in claim 1 wherein the distance measuring device is a portable laser rangefinder.

3. The apparatus as described in claim 1 wherein the distance measuring device is a portable sonar type rangefinder.

4. The apparatus as described in claim 1 wherein the angle measuring device is a gyroscope.

5. The apparatus as described in claim 1 wherein the angle measuring device is a theodolite.

6. The apparatus as described in claim 1 wherein the forming mechanism includes a computer and associated software connected to the memory.

7. The apparatus as described in claim 1 wherein the memory transmits the data to a remote computer that communicates with the forming mechanism.

8. The apparatus as described in claim 6 wherein the input device is connected to the computer and is manually directed by the operator, and the input device is at least one of a stylus, mouse or keyboard.

9. The apparatus as described in claim 6 wherein the input device is capable of receiving a pre-existing digitized blueprint and transmitting the blueprint to the computer.

10. The apparatus as described in claim 6 wherein the computer and associated software adjust the scale of the line segments of the first linear representation based on the distance measurements stored in memory.

11. The apparatus as described in claim 10 wherein the computer and associated software adjust the relative angles between the line segments of the first linear representation based on the angle measurements stored in memory.

12. An apparatus for establishing, on-site, a two dimensional floor plan for a physical structure, comprising:
a portable computer capable of running software;
at least one input device to manually sketch initial first dimensions of objects within a physical structure onto a display screen of the computer;
a portable device for measuring distances between objects within a structure;
a portable device for measuring relative angles between objects within a structure;
means to transmit linear and angular measurements to the computer;
a memory which receives and stores the distance and angle data; and
customized CAD software running on the computer that is configured to calculate an appropriate display scale to show on the screen, and to adjust the first linear representations so that they conform to the calculated display scale, and to adjust the relative angles between objects based on the measurements received from the portable measuring devices.

13. The apparatus as described in claim 12 wherein the memory includes a mechanism for displaying a menu having symbols of features, including a door and a window on the screen, said symbols able to be chosen from the menu and placed in the line segments on the screen of the first room data, said displaying mechanism connected to the computer.

14. The apparatus as described in claim 13 wherein the memory includes a mechanism for editing the line segments of the room data, said editing mechanism connected to the computer.

15. A method for establishing a two-dimensional exterior layout of a physical structure, comprising
forming a first representation of the layout with a computer and input device;
displaying the first representation of the layout on a screen;
placing a portable scanning device adjacent to an exterior corner of the structure;
scanning the distances and relative angles between all adjacent exterior walls; and
transmitting the distances and relative angles to the computer so that it can adjust the lengths and angles of the initial linear representations to match an appropriate display scale.

16. The method as described in claim 15 wherein the input device is capable of receiving a preexisting digitized blueprint and transmitting the blueprint to the computer.

17. The method as described in claim 15 wherein the input device is connected to the computer and is manually directed by the operator, and the input device is at least one of a stylus, mouse or keyboard.

18. A method for generating a digital, two-dimensional floor plan for a physical structure, comprising the steps of:
creating a first linear representation of a first object of the structure on the display screen of a portable computer running CAD software using at least one input device;
pointing a device that measures the distance from the starting corner position of the first object to the ending corner position;
transmitting the distance data to the computer;
calculating the ratio between the first linear object representation and the measured linear dimension of the object;
displaying the adjusted wall length on a display screen;
drawing a linear representation of a second object that is adjacent the first object;
pointing the distance measuring device from the ending corner position of the first object, to the far corner position of the second object to measure a new distance;
pointing a device that measures the relative angle between the second object and the first object;
transmitting the second distance and angle to the computer, so that the length of the second linear representation can be adjusted to match an appropriate display scale, and the relative angles between the objects can be adjusted to match the measured relative angles;
displaying a revised representation of the adjusted wall on the display screen; and
repeating the previous four steps until the relative lengths and angles of every exterior object of the structure are calculated and displayed onto the screen.

19. The method as described in claim 19 including after the first exterior scanning step, there are the steps of:
removing the distance and angle measuring devices from the exterior of the building;
placing the distance and angle measuring devices at or near a corner of a first interior room, the first room located in a corner of the building;
directly measuring the dimensions of the two nearest walls, and the relative angles between them, using the distance and angle measuring devices;
measuring the distance and angle from the first initial corner to the distal corner that is furthest away from the initial corner;
transmitting the distance and angle data to the computer;
calculating the dimensions of the two furthest walls by a triangulation technique;
scaling of data to conform to the previously determined scale; and
displaying a revised representation of the adjusted interior walls on the display screen.

20. The method as described in claim 20 including after the first interior scanning step, there are the steps of:
removing the distance and angle measuring devices from the first interior room of the building;
placing the distance and angle measuring devices at or near a corner of a second interior room, the second room adjacent the first room;
directly measuring the dimensions of the two nearest walls, and the relative angles between them, using the distance and angle measuring devices;
measuring the distance and angle from the initial corner to the distal corner that is furthest away from the initial corner;
transmitting the distance and angle data to the computer;
calculating the dimensions of the two furthest walls by a triangulation technique;
scaling of data to conform to the previously determined scale; and
displaying a revised representation of the adjusted interior walls on the display screen.
